(19) United States
(12) Patent Application Publication
(10) Pub. No.: US 2012/0242601 A1
(43) Pub. Date: Sep. 27, 2012

(54) Assembly Of A Display Apparatus And A Remote Control And A Method Of Operating The Assembly

(75) Inventor: Allan Agerholm, Viborg (DK)

(73) Assignee: BANG & OLUFSEN A/S, Struer (DK)

(21) Appl. No.: 13/416,790

(22) Filed: Mar. 9, 2012

(30) Foreign Application Priority Data
Mar. 21, 2011 (DK) PA 2011 00194

(51) Int. Cl. G06F 3/041

(52) U.S. Cl. 345/173

(57) ABSTRACT

An assembly of a display apparatus such as a TV and a remote controller, where the TV displays information from a first source such as a first TV channel while forwarding common information such as an EPG to the remote controller which displays the EPG information. The user may, on the remote controller, identify a second source, and the TV is then instructed to switch to the second source or channel. The mode of displaying the EPG information on the remote controller may be entered by rotating the remote controller, and the mode may be exited by the identification on the remote controller of the second source or a further rotation of the remote controller.

This application is a U.S. non-provisional application and claims priority under 35 U.S.C. §119 to Danish application number PA 2011 00194, filed Mar. 21, 2011, the entire contents of which is hereby incorporated herein by reference.

The present invention relates to a unified navigation and user interaction method related to interactive multi-media systems and in particular to a system and method in which a remote control may be used for navigating in common data, such as an Electronic Program Guide or an overview of events, while one event, such as a TV program is provided by the TV or monitor.

Such interactive multi-media systems including A/V equipment, TV sets, Audio sets, PC's, laptops, smart phones and portables like iPad/iPod and the like, where all units may be connected via wired-/wireless local networks and to the Internet. In the art, these types of system are well known and are becoming more and more complex to operate as a consequence of the increasing offering of digital information residing on networks, to be provided to a user.

An object of the invention is to offer operational means that might simplify the user's access to the digital information; this to obtain a maximum of convenience to the user in operating a multimedia system.

The navigation and user interaction is based on two way data communication principles among the units that constitutes a multimedia system, and is performed in an interactive mode of operation.

In a first aspect, the invention relates to an assembly of a display apparatus and a remote control, wherein:
the remote control comprises:
   one or more operatable instruction elements,
   a transmitter for outputting controlling information corresponding to operation of the instruction elements,
   a receiver for receiving image information from the display apparatus, and
   a first display for displaying the received image information,
the display apparatus comprising:
   a second display,
   a first receiver for receiving the controlling information,
   a second receiver for receiving source image information from a plurality of sources as well as common image information representing or describing the image information from the plurality of sources,
   a transmitter for transmitting the common image information to the remote control,
   a controller operatively connected to the display and the first receiver and being adapted to receive the controlling information and act accordingly,
      wherein the controller is operatively connected to the transmitter and is adapted to instruct the second display to provide the image information from one of the sources while instructing the transmitter to output the common image information.

In the present context, the assembly of the display apparatus and a remote control may be any type of equipment, such as A/V equipment, TV sets, Audio sets, PC's, laptops, smart phones and portables like tablets, iPad/iPod and the like. The display apparatus has a display and may be any of such types of equipment. It is realized that today, most display apparatus has a processor and communication capabilities and thus may perform multiple functions, such as the accessing and providing of any type of event as well as communicating with other apparatus.

The remote control may be a special purpose remote control generated for the particular display apparatus, as it is seen especially in legacy multimedia sets, or the remote control may itself be a cell phone, smart phone, iPad, iPod, Tablet PC, laptop PC, or the like. Usually, the remote control is handheld or portable and therefore typically battery operated and with a weight of no more than 1 kg, such as no more than 250 g. Also, a remote control may be no more than 30 cm, such as no more than 25 cm along its longest/largest dimension.

In this context, an operatable instruction element naturally may be a button or other physically operatable element, such as a rocker switch, a rotatable wheel/element, or the like. However, also other types of elements can be used. Touch pads or touch displays are widely used in cell phones, smart phones, tablets, iPads, iPods and the like, and such elements are very useful as user interfaces for many types of equipment. In addition, sound instructions (spoken words for example) may be used via a microphone, as may movement instructions detected either via a camera or a movement sensor (such as an accelerometer, vibration sensor, gravity sensor or the like). A deformation sensor (such as a strain gauge or a piezo electric element) may detect vibration/deformation which may also be used as an instruction.

The transmitter may be adapted to transmit any type of signal or information. The signal/information may be output over wires (electric signals or optical signals) or wirelessly, whereby the transmitter may be a wireless transmitter or a transmitter, such as a NIC or other hardware for transmitting signals/instructions over wires. Signals over wires may be transported over electric wires or as an optical signal in an optic fiber or the like. Wireless signals may be transmitted using any wavelength, such as ultra sound, radio signals or optical signals (IR, NIR, visible colors, UV, or the like). A large number of wireless standards exist, such as wireless Ethernet, WiFi, Bluetooth, or the like. Wireless communication between legacy remote controls and TVs is usually performed using IR radiation.

Naturally, the first receiver is adapted to receive the information output by the transmitter.

The controlling information corresponds to the operation of the instruction elements, and the controller is adapted to receive this controlling information and act accordingly. In a simple embodiment, the controlling information outputs an identity or other data corresponding to the instruction element(s) operated or the manner in which they are operated, so that no interpretation or analysis of this controlling need be performed in the remote control. In more complex embodiments, an interpretation may be performed in the remote control to output a more standardized or altered output on the basis of the input received. In this manner, different remote controls with different operatable elements may still output the same type of controlling information, and/or a number of instruction inputs using the operatable elements may be combined into a single instruction or fewer instructions.

The controller is adapted to receive the controlling information and act accordingly. Thus, the controller is adapted to receive this information and interpret it. Whether the remote control has interpreted the inputs or not, the controller is able to determine from the controlling information what is required. The controlling information may be information instructing the display apparatus to alter a sound output (volume up/down, filtering, muting, altering right/left/back/front sound balance or the like), alter which source image is displayed on the second display, turn the display apparatus on/off or bring it into a sleep mode. Also other parameters may be remote controlled, such as a physical height/rotation of the display apparatus, visual parameters of the image displayed by the second display (color balance, display format (e.g. 4:3 or 16:9), light intensity or the like). Naturally, also the providing of the common information to the remote controller may be controlled therefrom.

Therefore, this “correspondence” between the operation of the instruction elements and the controlling information means that the processor is able to determine what instruction elements were operated and what the user intended by this operation.

Naturally, the first and second displays may be based on any technology, such as CRT, LED, LCD, OLED, plasma or the like. The first and second displays may have any size and may be of the same or different types.

The display apparatus has a receiver for receiving source image information from a plurality of sources as well as common image information representing or describing the image information from the plurality of sources. In this context, a source may be a TV/radio channel, or a video/audio source (DVD, Blu-Ray player, tuner, set top box, electronic storage, disc array or the like). Naturally, the information received from the source may be streamed or downloaded completely, if this is desired.

In this respect, the common image information is visual information (information which may be provided to a display for a user to view) describing the information from the sources.

Naturally, the source information may stem from many sources and be many types of information, for example, Audio-Video (TV), Video (including DVD and Blu-Ray), Audio (including CD), Photo/image/picture, Book (book reader), Text (e.g. e-mail), Podcast, Streams (audio, video, radio, TV, etc) and/or Public services (including YouTube and Spotify).

The actual source information or common information may have any form, such as the types of signals received from analog or digital antennas, set top boxes, satellite receivers, file transfer of any type (including MP3, MP4, WAV, MPEG and any other standard used for transferring images, video, audio, or the like), or the like. The information may be streamed, transferred as a bulk file transfer or a combination thereof. In one situation, only a first part of the information may be transmitted, where after an instruction or a period of time is awaited until a second part is transmitted.

When the sources are standard TV channels, the common information may be an Electronic Program Guide which displays to a viewer the individual TV programs/sources (presently provided and/or provided in the future) available to the user.

The same type of program guide may be provided for audio/radio sources, and naturally, all other sources (DVD, Blu-Ray etc) may easily be added to such program guides.

Alternatively, the sources may be individual files, events, images, pictures, documents, and/or the like, to which the display apparatus has access. This access may be from a local storage, such as an internal or close-by storage (such as a hard drive, flash memory, RAM, ROM, PROM, EPROM, EEPROM, or the like) or a more remote storage accessible via a network (internal and/or the internet) such as if situated on one or more servers. In general, the common information then may be a list of identifiers of the files/events/images/pictures/documents or the like.

The common information describes the information from the sources. Different types of information may be desired for different types of source. Depending on the type of information, a large number of types of information may be provided. In many situations, such information is already today forwarded to the user either with the actual information (EPG transmitted with a TV channel, metadata (title, author or the like) forwarded with a streamed TV/radio channel downloaded audio file or on a purchased disc, and the like). All such types of information may without exception be used according to the present invention. Naturally, all such types of information may be provided on a display, as this is already today the way such information is provided.

If the source is a TV or radio channel, titles of one or more present or future programs or shows may be the desired information. If the source is a DVD/Blu-Ray/tape/record player, the identity of the player and/or an identity of a medium (disc, movie, show, book, tutorial or the like) presently available from/on/in the player may be the desired information.

If a source is a document, the title thereof may be the desired information. Alternatively, the author may be the information sought by a user.

If a source is an audio file, the title and/or the artist may be the desired information. Additionally or alternatively, the producer, production year, record label, genre or the like may be provided.

The common image information may be received from another source, which may be external to the display apparatus, or information relating to the different sources may be gathered or combined into the common image information in the display apparatus. Naturally, a combination may also be used, such as in the situation where an external EPG is received and combined with information relating to other available sources, such as radio channels, image libraries, DVD/Blu-Ray players or the like.

The transmitter is adapted to output the common image information to the remote control. This common image information may also be provided on the second display or may be received, by the second receiver, in a manner or of a type suitable for providing on the second display so that a conversion is required/desired, such as a reduction in resolution in the situation where the first display is smaller than the second display or where a relative low bandwidth is available from the transmitter to the receiver of the remote control. Naturally, any required conversion may also be performed in the remote control.

According to the invention, the controller can control the second display to provide the image information from the one of the sources while transmitting the common image information to the remote control, so that the user may view the common image information on the remote control display without interrupting the viewing or providing of the other source information on the second display. In this manner, one viewer may analyze the common image information on the remote control and others may continue viewing what the display apparatus provides.

In this context, the common image information may be provided as a bulk file transfer to the remote control, the information may be streamed, or relevant parts thereof may be transmitted (as separate files or streamed) from the display apparatus to the remote control, where the user may select interesting parts (such as by flipping pages or scrolling, navigating in a tree structure of images or the like) by using the operatable elements, whereby corresponding information is transmitted to the display element and the selected parts of the common image information returned to and displayed by the remote control.

In one embodiment, the remote control comprises a touch pad forming the instruction element(s) and the first display. Naturally, multiple touch pads and/or displays may be provided in the remote control, where one display/touch pad may provide the received common image information and a(nother) touch pad may constitute or form part of the operational elements.

Naturally, the display apparatus may be instructed to commence with the transmission of the common information by the remote control, such as by using the instruction elements. Also, when this transmission is no more desired, such as when another source has been identified, which may also take place using the instruction elements, another instruction may be forwarded to the display apparatus for providing on the second display the identified source and/or stop transmitting the common information.

A preferred embodiment relates to a manner of handling or operating the remote control in order to enter and exit the mode where the common image information is provided on the remote control. In this embodiment, the remote control comprises a direction sensor and a processor operatively connected to the direction sensor, the processor being adapted to instruct the transmitter to output first controlling information, when the sensor is brought into a first direction, and second controlling information, when the sensor is brought into a second direction different from the first direction, the controller being adapted to instruct the transmitter to, when receiving the first controlling information, transmit the common image information and, when receiving the second controlling information, instruct the second display to provide the image information from a source identifiable from the second controlling information.

In this respect, a direction sensor may be one of a large number of types of sensors, such as sensors determining a relative rotation or a rotation of an element in relation to a fixed coordinate system, such as the earth. Such sensors may operate by sensing the relative direction of gravity or the earth's magnetic field in relation to the sensor. In another situation, the sensor may comprise an accelerometer or gyro so as to be able to determine rotation along one or more axes.

Naturally, the “direction” of the remote control may be the direction of any part of or any axis of the remote control. Usually, the direction of the remote control will be one of the two main sides of a square-shaped display thereof, or the direction of lines of text on the operatable elements thereof, as the user uses these as main indicators of which way to rotate the remote control during use. However, any element or part of the remote control may be used for defining an axis of the remote control, where the direction of the remote control then may be the direction of the axis in any suitable coordinate system or in relation to any element, such as the display element, a user, gravity, or the like.

Preferably, the first and second directions are directions of a side of the first display, when this is quadratic. Then, the first direction may be at least substantially perpendicular to the second direction, whereby the two directions relate to rotation of a monitor or cell phone, where the image provided on the first display may even be rotated, as is known from most smart phones today. Such smart phones—and other monitors—comprise a direction sensor which informs a controller of the direction of the display, so that the information provided on the display is adapted to the direction, and is the display rotated 90 degrees in relation to (typically) gravity, the image provided on the display is rotated 90 degrees in relation to the display.

Thus, when the remote control is in one direction (the side is vertical, for example), the first controlling information is transmitted, and the controller facilitates the transmission of the common image information, so that the user, when providing the remote control in this direction, makes the remote control provide the common image information.

When the user has finished reviewing the common image information, he rotates the remote control to the other direction, such as so that the side is horizontal, whereby the second controlling information is sent and the controller has the second display now display image information from a source identifiable from the second controlling information.

The user may identify, before rotating the remote control, the new source, or this source may be derivable from the operation of the remote control before rotating. Thus, the source may be identified as that which is centered, at the top or the like of the first display, when the remote control is rotated. Alternatively, all information on the first display may relate only to or mainly to that source, when the rotation takes place, or the user may highlight or otherwise identify the source before or at rotation.

Naturally, the identification may also take place after rotation, where the remote control may await such identification before transmitting the second controlling information.

Also, a combination may be desired where the initial rotation of the remote control initiates the transmission of the common information and the displaying thereof on the first display, and the identification may be performed not by rotation but by other operations of the operatable elements.

Finally, the actual identification of another source may also be taken as an instruction to inform the display apparatus thereof and go to the displaying of information from that source and optionally also stop transmitting the common information.

That the source is identifiable from the second controlling information means that the controller from this information may derive the identity of the source and thereby instruct the second display to now provide received image information from the identified source. This information may be the source identity, number, or the like, or may be an identification of an event, a file, or the like provided or to be provided from the source. Needless to say, this identification may be made in a wide variety of manners, as long as the controller is able to ascertain the identity of the desired or identified source.

Another aspect of the invention relates to a method of operating an assembly of a remote control, having a first display, and a display apparatus having a second display, the method comprising:
1. the display apparatus receiving source image information from a plurality of sources as well as common image information representing or describing the image information from the plurality of sources,
2. the display apparatus being operated to display the source image information from a first of the sources on the second display,
3. the remote control being operated to have the common image information provided on the first display, while the display apparatus provides the source image information from the first source on the second display,
4. the remote control receiving, while the display apparatus provides the source image information from the first source on the second display, an input identifying a second source different from the first source, and
5. the remote control instructing the display apparatus to provide the source image information from the second source on the second display, the display apparatus subsequently providing the source information from the second source on the second display.

Preferably, the communication between the display apparatus and the remote control is wireless, even though communication over wires is possible and feasible.

The remote control preferably is portable and handheld and thus battery operated. Alternatively, the remote control may have elements for harvesting electromagnetic energy from the surroundings, such as from WiFi networks and/or from impinging radiation, using solar cells or the like.

The display apparatus may receive the source image information and common image information from the same element, such as an antenna or a plug/connector, or the display apparatus may comprise a number of communication elements and thus receive the information from a number of inputs and subsequently generate the common image information itself. In one situation, the display apparatus is connected to a gathering element receiving the different source image information and generating the common image information for the display apparatus.

As described above, a “source” may be a variety of things from a separate TV/radio channel to an image on a storage. The source image information may be a received, streamed signal or a stationary image received or held in a storage.

Displaying this source image information is standard technology, as is the actual technology of the displays and the receivers/transmitters preferably.

Preferably, the remote control is adapted to have the user, via the remote control, control different parameters of the display apparatus, such as a rotation thereof, parameters of the image provided (light intensity, color temperature etc.), parameters of any sound provided (filtering, volume up/down, controlling right/left/back/front/center balance) etc. Additionally, the remote control may be used for controlling the display apparatus directly to provide the image information from another source or simply to turn on/off or enter/exit a sleep mode.

According to this aspect of the invention, the display apparatus provides the image information from one source when the remote control is operated to receive and provide the common image information, where after the display apparatus may proceed providing the image information from the source while the common image information is provided by the remote control. Finally, the remote control receives an input identifying another source, and the display apparatus is instructed to subsequently provide the image information from that source.

Again, the common image information may be provided to the remote control as a result of a request fed from the remote control to the display apparatus, and the transmission of the common image information to the remote control may be the feeding of a complete file to the remote control or identification or requesting of parts thereof which are subsequently fed to the remote control, so that the requesting of the (parts of the) common image information takes place a number of times during the time the display apparatus provides the image data from the source.

In one embodiment, step 3 comprises the display apparatus outputting the common image information and the remote control receiving the common image information.

In a preferred embodiment, step 3 comprises:
bringing the remote control from having a predetermined axis point in a first direction into a second direction, different from the first direction, and transmitting first controlling information to the display apparatus, and
the display apparatus receiving the first controlling information and outputting the common image information,
   and wherein step 5 comprises:
bringing the remote control from having the predetermined axis point in the second direction into the first direction, and transmitting second controlling information, comprising information identifying the second source, to the display apparatus, and
the display apparatus receiving the second controlling information.

As mentioned above, the axis may be any axis of the remote control, such as a side of the first display, if it is quadrangular, or a direction of lines of text when provided on the display.

An alternative is to enter the mode where the display apparatus transmits the common information by operating the operating elements.

Also, this mode may be exited by the user identifying the second source. This may be taken as an instruction to instruct the display apparatus to display the information from the second source and optionally to stop transmitting the common information.

Such operations of the remote controller may be combined with the rotation if desired, for example such that the mode may be entered by a rotation of the remote controller and exited not by a rotation but by the user identifying the second source.

Another aspect of the invention is a method for an interactive multi-media system that consists of one or more a multimedia providers and one or more remote controllers to act in a synchronized mode of operation, the method of synchronization including:
a data structure, such as an EPG or other common image information, with it's content is provided on a multimedia device;
the data structure and the content is accessed and controlled via a wireless interactive two way remote controller operated by the user;
a first gesture performed via or by the remote controller, e.g. a gesture in which the orientation of the controller is moved from a first position (upright vertical) to a second position (horizontal) and
   a specific event/command related to the first gesture is sent from the remote controller to the multimedia device that's under control, and
   the data structure with it's content is replicated from the multimedia device that's under control to the remote controller, and is provided on the remote controller which remote controller enters a mode of control accordingly, and
   the multimedia device that's under control enters a mode of control accordingly.

Another embodiment of this aspect of the invention is that a second gesture performed via or by the remote controller, e.g. a gesture in which the orientation of the controller is moved from a second position (horizontal) to a first position (upright vertical) implies a reverse action to take place.

According to this mode of operation of the remote terminal, the reverse action may reestablish the device under control and the terminal itself to the actual modes and states prior to when the first gesture was given.

A dedicated control command given by the user may force the remote terminal to execute an action alternatively to the reverse action.

Alternatively to the first and second gesture to be applied as a trigger event other options may be applied:
any gesture provided with or via the remote terminal, the gesture to be a movement relative to the position of the device under control;
a hand/finger of the user being close to—or in the proximity of the touch surface of the remote terminal;
a hand/finger of the user provides a touch/pressure of the touch surface of the remote terminal.

The multimedia device under control may be in one or more of several modes of control, e.g. the modes being, but not limited to:
off, waiting for command signals;
on, and active and providing content from a digital source of information;
on, and active and providing index information (e.g. an ERP) to the user;
on, and active and supporting the user in control and navigation (e.g. access to and control of an ERP);
on, and monitoring and accepts mode shift events issued from the remote terminal;
on, communicating data and control to/from the remote terminal.

The remote controller device may be in one or more of several modes of control, e.g. the modes being, but not limited to:
off, waiting for user action, and entry of commands;
on, and active and providing content sent from a digital source of information, via the device under control;
on, and active and providing index information (e.g. an ERP) to the user;
on, and active and supporting the user in control and navigation (e.g. access to and control of an ERP);
on, and monitoring and accepts mode shift events issued from the device under control;
on, communicating data and control to/from the device under control.

The multimedia device under control and remote controller device may be in one or more of several states of control, e.g. but not limited to: enabled for Audio/Video input, enabled for providing TV signals and providing digital streams.

Summary of this aspect of the invention is:
Multimedia system under control from a wireless controller, two way interactive.
Fully synchronized digital data and information share among the remote and the device under control.
Same principles for accessing, controlling and providing all media information (e.g. Audio, Video, Photo, Streams, Book, Text) ordered in a listed hierarchy.
Remote controller:
   wireless, two way,
   one or two displays, touch sensitive,
   alternatively one physical display with two or more logical displays
   touch pad, physical keys, virtual keys,
   adapts data structures (e.g. EPG) from the device under control (e.g. TV set), dynamic update,
   adapts automatically the data structure when the physical orientation is changed,
   gesture up/down supplemental to—or alternative to touch up/down command,
   adapts/synchronizes in general all UI, graphics, navigation hierarchies, mode of operation from the device under control.

In the following, preferred embodiments will be described with reference to the drawing, wherein:

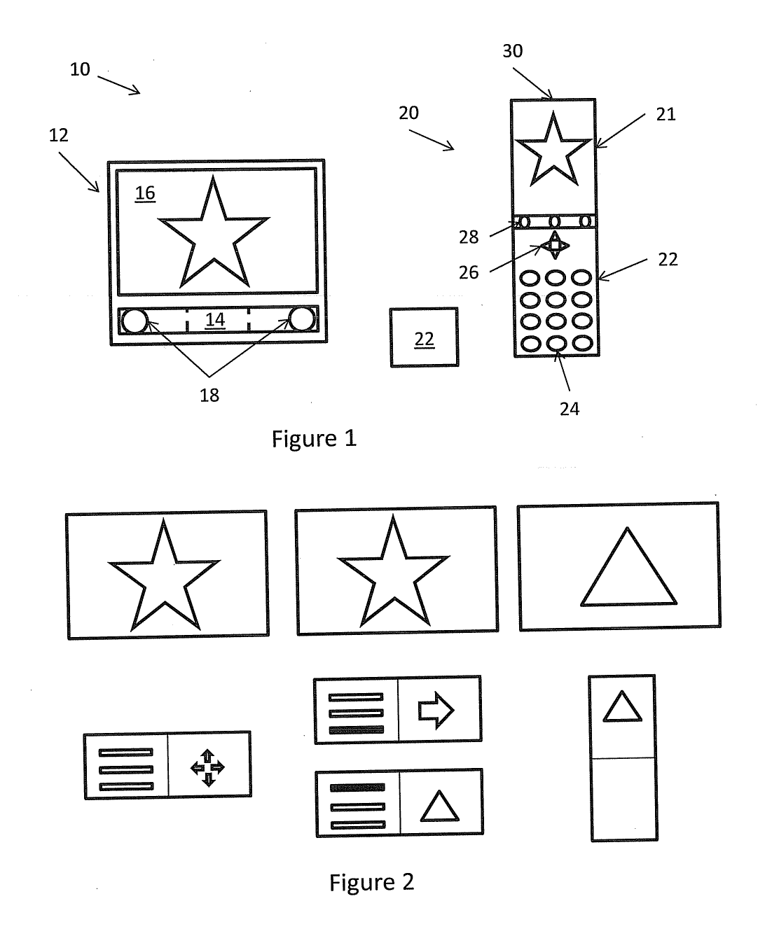

FIG. 1 illustrates an assembly according to the invention,

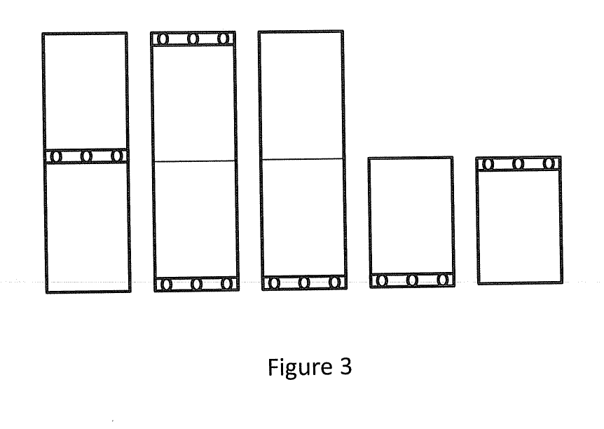

FIG. 2 illustrates a method according to the invention, and

FIG. 3 illustrates alternative configurations of the wireless remote controller

FIG. 1 illustrates an assembly 10 comprising a display element 12 here in the form of a multimedia device such as a TV having a display 16 and stereo speakers 18 as well as a communication and controller unit 14 illustrated in a hatched box, as it would normally not be visible on the TV 12. Naturally, the multimedia device 12 will be able to provide any type of information, such as digital information. Thus, the display 16 may be adapted to provide 2D or 3D images and the speakers 18 may be for stereo reproduction or any multiple channel reproduction.

The assembly 10 also has a remote control 20 for controlling the TV 12 in the usual fashion using numeral buttons 24 and a navigation element 26 for controlling channel selection (up/down) and volume (up/down). In this embodiment, the RC 20 has two displays 21 and 22 of which at least the display 22 is a touch display presently used for providing the buttons/element 24/26. Additional buttons 28, such as old-fashioned push buttons, may be provided for controlling other elements of the TV 12, such as color parameters of the display 16 or audio parameters of the sound generated by the speakers 18.

Presently, the display 21 provides the same information or image as the display 16. This display may be used for a large variety of types of information. It may also provide information from another source of information received by the TV 12 and forwarded to the RC 20.

The communication element 14 communicates with a transceiver unit 30 of the RC 20, so that the RC 20 may output instructions, based on a user's operation of the buttons/elements 24, 26, 28 and other input means described further below, and so that the TV 12 may receive such information or instructions and act accordingly.

Naturally, the element 14 and the transceiver unit 30 comprise an antenna (for electromagnetic signals) or receiver/transmitter (e.g. for optical signals) and a processor/controller (not illustrated) communicating also with the respective displays 16/21/22, the speakers 18, the buttons 28 as well as other inputs/outputs. For example, the TV will have one or more elements, such as an antenna input or a Scart or HDMI plug or the like for receiving image information from an outside source 22, such as a set top box, an antenna, a satellite receiver, a Blu-Ray/DVD/CD/tape player, or the like. Externally (element 22) or internally (in element 14), further information may be provided which is available to the TV 12, such as a storage of images, movies, shows, podcasts, music files or the like, provided in e.g. a disc storage, a RAM/ROM/PROM/EPROM/EEPROM/flash memory or the like. Alternatively, the element 22/14 may be or comprise a CDROM/CD/DVD/Blu-Ray reader so that at least part of the information may be provided on one or more CDROM/CD/DVD/Blu-Ray discs. Alternatively or additionally, the element 22/14 may be or comprise a card reader, such as for reading flash memory cards, where at least part of the information is present on one or more flash memory cards.

The TV receives image information from one or more sources as well as common image information describing the information from the sources. As described above, a source may be a TV/radio channel, a source of streamed events (music, shows, programs or the like), an available storage section or part of a storage, or the like, where the storage may be internal, close by (available by e.g. a LAN) or remote (available over the internet) and may be a hard disc, card, disc or any other type of storage. Thus, the common image information is adapted to be provided on the display 16 and describes available sources, such as in the form of an EPG, if the sources comprise TV channels, or other forms of lists of available sources. If the sources are available storage sections of a storage in which individual files (movies, images or the like) are stored, the common image information may provide information relating to each individual file, such as a title thereof or other relevant information.

The common image information may be received from an external source, such as unit 22 or may be generated by the unit 14 of the TV.

Naturally, the controllers/processors of the unit 14 and the transceiver 30 will be able to not only control elements of the TV 12 and RC 20 but also perform any signal processing or conversion relevant in order for the instructions entered on the RC 20 to be forwarded to and interpreted in the TV 12. A controller/processor may each be a software-controlled processor and/or a hardwired processor, such as a special purpose FPGA or ASIC.

In addition, the transceiver 30 may comprise a direction sensor in order for the user to be able to introduce instructions by providing the RC 20 into a predetermined direction or alter its direction in a predetermined manner.

This is illustrated in FIG. 2 which, from left to right, describes three steps of a process starting with either a situation in which the TV is turned on or in sleep mode or (subsequently) the situation seen in FIG. 1, where the TV 12 provides information from a source and where the RC 20 may receive this information (the image or e.g. a source ID) and provide it on the display 21. In this situation, the usual RC commands of altering the channel (entering a number on numerical buttons or channel up/down commands) may be used, as may all other manners of remote controlling the TV, such as adapting the volume.

Thereafter (FIG. 2 left), the user rotates the RC 20 so that its main axis is horizontal. This is sensed by the direction sensor and a corresponding instruction is transmitted to the unit 14 of the TV, which now transmits the common image information to the RC 20 which provides it on one of the displays 21 and 22. The other of the displays 21/22 may keep providing the information provided on the TV 12 (as in FIG. 1), may be used for providing navigation capabilities in the common image information (FIG. 2 left) or may, when the user navigates through the common image information (FIG. 2 center) be used for providing the information from a source presently analyzed in the common image information, for example.

Clearly, if the displays 21/22 are touch displays, the number of types of activatable areas and the functionality of the RC may vary in different situations, such as when in the two different directions.

Naturally, many manners exist of providing a list of sources. Lists of this type may be seen in the ways EPGs are presented today on TV screens, the way files, such as images or music files, are presented on user interfaces and the like. The user may navigate therein and request further information (where an instruction is then forwarded to the TV to forward that further information to the RC) etc. as it is possible today on TVs computers and the like.

The transmission of the common image information from the TV to the RC may be the transmission of a single file or may be a sequence of transmission of relevant parts, such as if the user scrolls or “flips pages” in the common image information. Together with this, the user may be able to select or highlight (see black part of common image information in FIG. 2 center) a source, where after corresponding information is provided to the TV which now transmits information from this source to the RC so that it may be provided on the other display, if desired.

The user may now navigate in the list. FIG. 2, center, illustrates this navigation by providing two images of the RC 20 at different points in time while navigating. In the upper illustration, the lowermost source is contemplated (darker), and the corresponding image has been received from the TV. When the user navigates further down, a scrolling may take place, or a “page may be flipped”. The next information to be provided may then, if not already present in the RC, be requested from the TV. In the lower illustration, this new information is provided and another (the uppermost) source is contemplated.

Once the user has decided on another source than that which is still provided on the TV, the user may select this (highlight it in any manner, for example) and rotate the RC to the vertical direction, whereby an instruction is transmitted to the TV to no longer transmit the common image information to the RC but, more importantly, to now provide the information from the selected source on the TV. Again, the ID of the new source, or the image therefrom, may be fed to the remote as in FIG. 1.

FIG. 3 illustrates alternative configurations of the wireless remote controller are available:
two screens and one centered area with control keys (physical or virtual),
two screens and two areas with control keys (physical or virtual),
two screens and one area with control keys (physical or virtual),
one screen and one area with control keys (physical or virtual).

Each screen may act as a touch sensitive display, a pure display or a combination of touch sensing and display as appropriate for the application.

Having two or more screens these may be two or more physical screens or one or more physical screens divided into a plurality of logical screens or a mix of physical and logical screens.

1. An assembly of a display apparatus and a remote control, wherein:
the remote control comprises:
one or more operatable instruction elements,
a transmitter for outputting controlling information corresponding to operation of the instruction elements,
a receiver for receiving image information from the display apparatus, and
a first display for displaying the received image information,
the display apparatus comprising:
a second display,
a first receiver for receiving the controlling information,
a second receiver for receiving source image information from a plurality of sources as well as common image information representing or describing the image information from the plurality of sources,
a transmitter for transmitting the common image information to the remote control,
a controller operatively connected to the second display and the first receiver and being adapted to receive the controlling information and act accordingly,
wherein the controller is operatively connected to the transmitter and is adapted to instruct the second display to provide the image information from one of the sources while instructing the transmitter to output the common image information.

2. An assembly according to claim 1, wherein the remote control comprises a touch pad forming the instruction element(s) and the first display.

3. An assembly according to claim 1, wherein the remote control comprises a direction sensor and a processor operatively connected to the direction sensor, the processor being adapted to instruct the transmitter to output first controlling information, when the sensor is brought into a first direction, and second controlling information, when the sensor is brought into a second direction different from the first direction, the controller being adapted to instruct the transmitter to, when receiving the first controlling information, transmit the common image information and, when receiving the second controlling information, instruct the second display to provide the image information from a source identifiable from the second controlling information.

4. A method of operating an assembly of a remote control, having a first display, and a display apparatus having a second display, the method comprising:
1. the display apparatus receiving source image information from a plurality of sources as well as common image information representing or describing the image information from the plurality of sources,
2. the display apparatus being operated to display the source image information from a first of the sources on the second display,
3. the remote control being operated to have the common image information provided on the first display, while the display apparatus provides the source image information from the first source on the second display,
4. the remote control receiving, while the display apparatus provides the source image information from the first source on the second display, an input identifying a second source different from the first source, and
5. the remote control instructing the display apparatus to provide the source image information from the second source on the second display, the display apparatus subsequently providing the source information from the second source on the second display.

5. A method according to claim 4, wherein step 3 comprises the display apparatus outputting the common image information and the remote control receiving the common image information.

6. A method according to claim 4, wherein step 3 comprises:
bringing the remote control from having a predetermined axis point in a first direction into a second direction, different from the first direction, and transmitting first controlling information to the display apparatus, and
the display apparatus receiving the first controlling information and outputting the common image information,
and wherein step 5 comprises:
bringing the remote control from having the predetermined axis point in the second direction into the first direction, and transmitting second controlling information, comprising information identifying the second source, to the display apparatus, and
the display apparatus receiving the second controlling information.
